(19) United States
(12) Patent Application Publication
(10) Pub. No.: US 2018/0211195 A1
(43) Pub. Date: Jul. 26, 2018

(54) METHOD OF PREDICTING PROJECT OUTCOMES

(71) Applicant: Khorus Software, LLC, Austin, TX (US)

(72) Inventors: JOEL TRAMMELL, Austin, TX (US); MICHAEL GREIG, Austin, TX (US); CHRIS PALMISANO, Austin, TX (US); MIKE JOHNS, Austin, TX (US)

(21) Appl. No.: 15/414,318

(22) Filed: Jan. 24, 2017

(51) Int. Cl. G06Q 10/06

(52) U.S. Cl. CPC G06Q 10/06312; G06Q 10/06398; G06Q 10/0635

(57) ABSTRACT

The disclosed subject matter provides for a method and system for predicting project outcomes. The present method and system for predicting project outcomes aids a project manager or CEO in quickly determining if projects are on track to be completed as scheduled, and what areas or personnel need assistance in meeting their project goals and deadlines.

### FIELD OF THE INVENTION

The present disclosure relates to project management. More specifically, the present disclosure relates to predicting project outcomes. It is to be understood that it also finds application in other usage scenarios and is not necessarily limited to the aforementioned application.

### BACKGROUND OF THE INVENTION

Generally, project managers need to know if a goal will be completed by the designated time. Accurately predicting the success or failure of completing a targeted goal allows managers to move resources to ensure the successful completion of the goal CEO's are often required to predict the outcomes of company-wide goals each quarter.

Current methods project management make heavy use of percent complete estimates (PC). In PC methods, project participants regularly update the percent of the project they have completed. These estimates only show the percentage completed of the project as planned prior to starting the project. These PC methods can be misleading due to the lack of other information, such as what quality of work is going into completing the project, or whether the project participants expect the project to be completed on time.

PC methods for project management can also encourage false reporting by project participants. In the PC method, project managers, superiors, and colleagues only see the percentage completed, so they will judge your performance based on how bight the percentage is. Because the percentage is the only indicator a participant is judged by, participants are encouraged to get tasks done by any means and mark the task complete to increase their percentage shown to superiors. This rush to mark tasks complete at all costs can lead to poor work product that will cause problems later in the project, or prevent the project from being completed.

In large organizations, a CEO will be prevented from directly observing the work product that goes into a project because he is on the other side of the world or in charge of hundreds to tens of thousands of project participants. The size of teams and geographical layout of teams requires a CEO or project manager to look at summaries of the work completed. When CEO's use PC methods to predict a project outcome and report the likelihood of the project completion to board members or shareholders, they often get the prediction wrong because they are lacking all of the necessary information.

In addition to the percentage of a project that has been completed, a CEO needs to know what areas of the project are experience problems, and if any of the work performed on the project is at a low enough standard to result in failures or delays further down the project timeline. Knowing which areas of the project are experiencing difficulties allows the CEO to re-allocate resources to ensure the project will be completed as planned.

In addition to needing information on problem areas, a CEO needs to know which project participants are the best indicators regarding project completion. When a CEO is looking at summaries he is unable to determine which project participant's reporting was considered more or less in the final report. Knowing that a seasoned and experienced employee thinks a project is not going to be completed despite every other employee saying the project will be completed on time can weigh heavily on a CEO reporting to the shareholders if a project will be completed. Finding the employee who is more accurate at indicating the likely outcome of a project is made more difficult today when there can be hundreds or tens of thousands of employees reporting individually each day. Finding the signal in the noise can mean a CEO gives an accurate report to board members and shareholders, resulting in the CEO keeping his job.

The need remains for a method that allows for improved understanding of whether a project goal will be completed.

### BRIEF SUMMARY OF THE INVENTION

Unless otherwise defined, herein all terms (including technical and scientific terms) have the same meaning as commonly understood by one of ordinary skill in the art to which this disclosure belongs. It may be further understood that terms, such as those defined in commonly used dictionaries, should be interpreted as having a meaning that is consistent with their meaning in the context of the relevant art and the present disclosure, and may not be interpreted in an idealized or overly formal sense unless expressly so defined herein.

The present disclosure provides for a method and system for predicting project outcomes. The present method and system for predicting project outcomes may aid a project manager, a CEO or a company in quickly determining if projects are on schedule, and what groups, teams, departments, areas, or personnel need assistance in meeting project goals and deadlines.

In some embodiments, a dashboard may present a matrix summarizing the input from project participant's encompassing their estimations of actual completion of the project.

In some embodiments, a dashboard may illustrate a completion indication representing the probability that the project will be completed as planned.

In some embodiments, a predictive index may provide for one or more project participants to indicate the project participant's ability to predict the probability of the completion of the goal or project.

The present disclosure addresses the shortcomings of prior systems and methods.

Descriptions of certain illustrative aspects are described herein in connection with the annexed FIGUREs. These aspects are indicative of various non-limiting ways in which the disclosed subject matter may be utilized, all of which are intended to be within the scope of the disclosed subject matter. Other advantages, emerging properties, and features may become apparent from the following detailed disclosure when considered in conjunction with the associated FIGUREs that are also within the scope of the disclosure.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 presents a schematic diagram of a system for predicting outcomes in a computer network, according to some embodiments.

FIG. 2 illustrates a computer processing system within which the process may operate, according to some embodiments.

FIG. 3 shows a process architecture according to some embodiments.

FIG. 4 depicts the process flow according to one embodiment of the disclosed subject matter.

FIG. 5 depicts the process flow for a manager or CEO, according to some embodiments.

FIG. 6 depicts the workflow for how the embodiment performs goal completion prediction.

FIG. 7 separately shows an alternative workflow for how to perform a goal completion prediction.

FIG. 8 depicts an exemplary workflow for creating a user predictive index.

FIG. 9 depicts a second exemplary workflow for creating a user predictive index, according to some embodiments.

FIG. 10 depicts an exemplary dashboard comprising a matrix output.

FIG. 11 presents an exemplary dashboard output comprising questions presented to a participant.

FIG. 12 presents an exemplary method for calculating a completion indication.

### DETAILED DESCRIPTION OF ILLUSTRATIVE EMBODIMENTS

Reference now should be made to the drawings, in which the same reference numbers are used throughout the different figures to designate the same components.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The terms “corpus” and “database” may be used interchangeably. As used herein, the terms “project participant” and “user” may be used interchangeably. Additionally, as used herein, the terms “project”, “objective”, “outcome”, and “goal” may be used interchangeably.

In addition to goal management functions, the organizational elements of flow up and flow down goals are captured in the definition of “projects”. “Project” is intended to include any organizational, social, business, or other activity, venture, task, program, plan, or task. The term “project” is not intended to be limiting to a business project. A user may use the organizational elements for any purpose that involves aligning various sub-departments or group efforts over time.

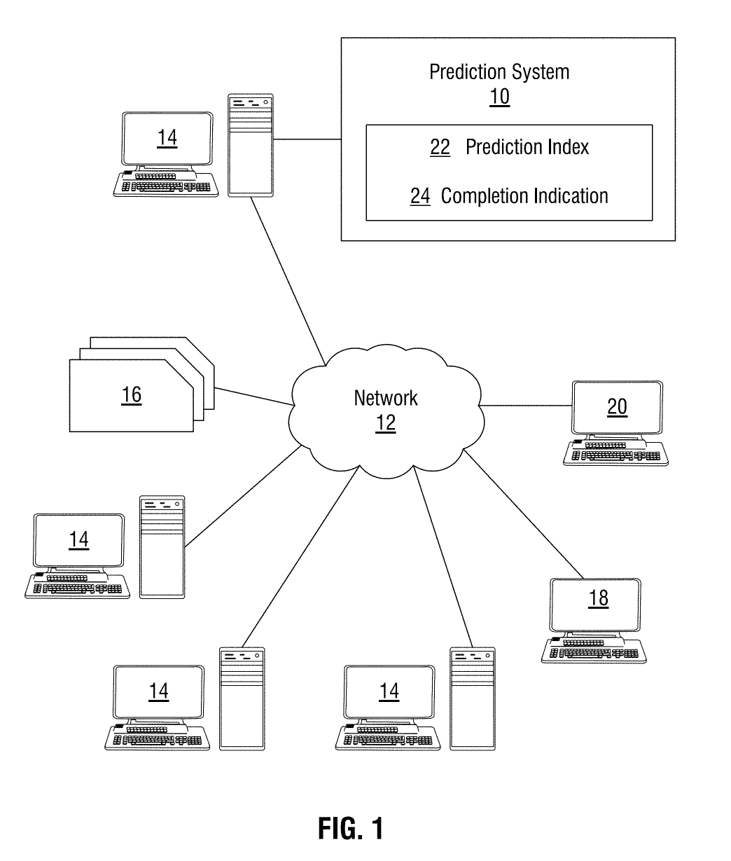

FIG. 1 presents a schematic diagram of an exemplary system embodiment for predicting project outcomes as may be deployed across a computer network. The system for predicting project outcomes (10) may be implemented in one or more computing devices (14), connected to the computer network (12). The computer network (12) may include multiple computing devices in communication with each other and with other devices or components through one or more wired and/or wireless data communication methods, where each communication method may comprise one or more of wires, routers, switches, transmitters, or receivers. The system for predicting project outcomes (10) and the computer network (12) may enable functionality for predicting project outcomes for one or more users through their respective computing devices (20, 111, 18). Other embodiments of the inventive subject matter may be used with components, systems, sub-systems, and/or devices other than those depicted herein.

The system for predicting project outcomes (10) may be configured to implement a method for calculating a predictive index indication (22). For example, the system for predicting project outcomes (10) may receive input from the computer network (12), a corpus of electronic documents (16), a user, databases, other possible sources of input, or a combination thereof. In one embodiment, some or all of the inputs to the system (10) may be routed through the computer network (12). The various computing devices (14) on the computer network (12) may include access points for content creators and users. Some of the computing devices (14) may include devices for a database storing the corpus of data (16), which is shown as a separate entity in FIG. 1. Portions of the corpus of data (16) may also be provided on one or more other network attached storage devices, in one or more databases, or other computing devices not explicitly shown in FIG. 1. The computer network (12) may include local network connections and remote connections in various embodiments, such that the system for predicting project outcomes (10) may operate in environments of any size, including local and global, e.g., the internet.

In one embodiment, the content creator creates content in a document of the corpus of data (16) for use as part of the corpus of data with the system for predicting project outcomes (10). The document may include any file, text, article, psychological profile, past project data, past input, or any combination thereof, for use in the system for predicting project outcomes (10). System users may access the system for predicting project outcomes (10) through a network connection or an internet connection to the computer network (12), and may provide input to the system for predicting project outcomes (10) through a network connection or an internet connection to the computer network (12). In one embodiment, the input may be formed using natural language. In another embodiment, the input may be formed by the user selecting an option such as a color-coded button, or a scale.

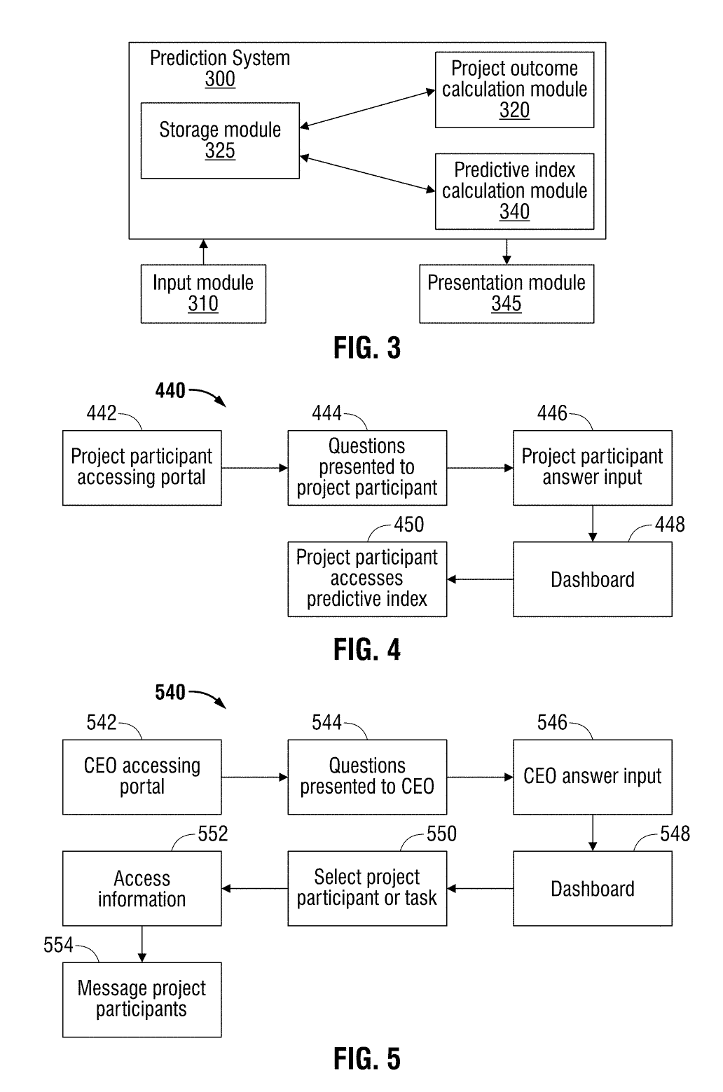

The system for predicting project outcomes (10) may implement a calculation to generate a predictive index indication (22), which comprises a plurality of stages for processing user input and the corpus of data (16), and generates a predictive index indication. The system for predicting project outcomes (10) may also implement a calculation to generate a project completion indication (24), which comprises a plurality of stages for processing user input and the corpus of data (16), and generates an indication of the likelihood of a project completion. The predictive index indication (22) and the project completion indication (24) will be described in greater detail with regard to FIG. 3.

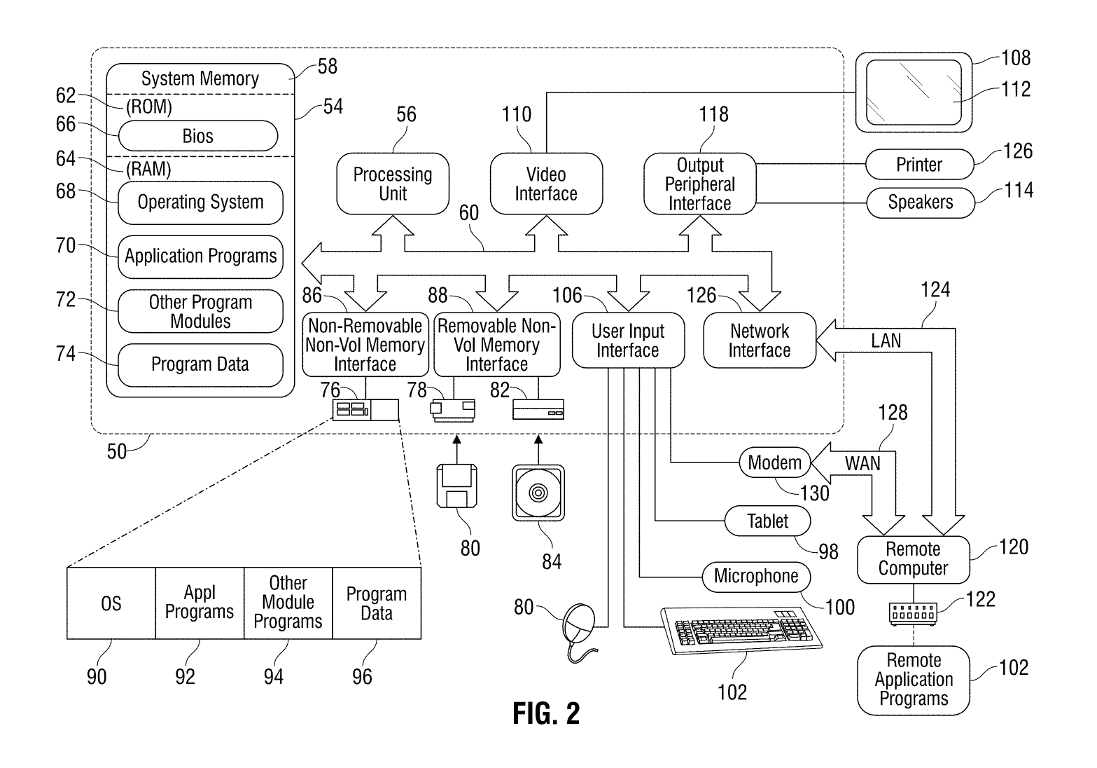

FIG. 2 illustrates a computer processing system within which the process of the present disclosure may operate. The data capture, analysis, and use of the method and system of the present disclosure may employ the use of a computing system associated with a three-dimensional camera system. Thus, with reference to FIG. 2, an exemplary system within computing environment (50) for implementing the disclosure includes a general purpose computing device in the form of computing system (52), commercially available from, for example, Intel, IBM, AMD, Apple, Motorola, Cyrix, etc. Components of computing system (54) may include, but are not limited to, processing unit (56), system memory (58), and system bus (60) that may couple various system components, including system memory (58) to processing unit (56). System bus (60) may be any of several types of bus structures including a memory bus or memory controller, a peripheral bus, or a local bus using any of a variety of bus architectures.

Computing system (52) includes a variety of computer readable media. Computer readable media can be any available media that can be accessed by computing system (52) and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system (52).

System memory (58) includes computer storage media in the form of volatile, nonvolatile memory, or the combination thereof, such as read only memory (ROM) (62) and random access memory (RAM) (64). A basic input/output system (BIOS) (66), containing the routines that help to transfer information between elements within computing system (52), such as during start-up, may be stored in ROM (62). RAM (64) may contain data, program modules, or the combination thereof, that are immediately accessible to and/or presently being operated on the processing unit (56). Some embodiments may further comprise an operating system (68), application programs (70), other program modules (72), and program data (74).

Computing system (52) may also comprise other removable/non-removable, volatile/nonvolatile computer storage media. In some embodiments, a hard disk drive (76) may read or write to a non-removable, nonvolatile magnetic media, a magnetic disk drive (78) that may read or write to removable, nonvolatile magnetic disk (80), and an optical disk drive 82 that reads from or writes to removable, nonvolatile optical disk 84 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The hard disk drive 76 may be connected to the system bus (60) through a non-removable memory interface (86) A magnetic disk drive (78) and optical disk drive (82) may be connected to the system bus (60) by a removable memory interface (88).

The drives and their associated computer storage media, discussed above, may provide storage of computer readable instructions, data structures, program modules and other data for computing system (52). In some embodiments, hard disk drive (76) is illustrated as storing operating system 90, application programs 92, other program modules 94 and program data 96. Note that these components can either be the same as or different from operating system (68), application programs (70), other program modules (72), and program data (74). Operating system 90, application programs 92, other program modules 94, and program data 96 are given different numbers here to illustrate that, at a minimum, they are different copies.

A participant may enter commands and information into the computing system (52) through input devices, such as tablet or electronic digitizer (98), microphone (100), keyboard (102), pointing device (104), or combination thereof. The pointing device may be any one of a mouse, trackball, or touch pad. The input devices may be connected to the processing unit (56) through a participant input interface (106) coupled to the system bus (60). In some embodiments, the processing unit (56) may be connected by other interface and bus structures, such as a parallel port, game port or a universal serial bus (USB).

Monitor (108) may be connected to the system bus (60) via a video interface (110). In some embodiments, display 108 may also be integrated with a touch-screen panel (112) or the like.

In some embodiments, the monitor, the touch screen panel, or combination thereof, may be physically coupled to a housing in which computing system 52 is incorporated, such as, for example, in a tablet-type personal computer or smart phone.

In some embodiments, the computing system (52) may also include other peripheral output devices such as speakers 114, printer 116, or the combination thereof, connected through an output peripheral interface 118 or the like.

In some embodiments, computing system (52) may operate in a networked environment using logical connections to one or more remote computing systems (120). The remote computing system (120) may be a personal computer, mobile electronic devices, a server, a router, a network PC, a peer device or other common network node. The remote computing system (120) may comprise one or more of the elements described above relative to computing system (52), although only a memory storage device (122) has been illustrated.

The logical connections depicted in FIG. 2 may include a local area network (LAN) (124) connected through network interface (126), a wide area network (WAN) 128, or combination thereof, connected via modem (130). In some embodiments, the logical connection may also include other networks such as mobile telephone service networks. Such networking environments are utilized in offices, enterprise-wide computer networks, intranets, mobile networks, and the Internet.

For example, in the present embodiment, computer system (52) may comprise the source machine from which data may be generated/transmitted and the remote computing system 120 may comprise the destination machine. Note however that source and destination machines need not be connected by a network or any other means, but instead, data may be transferred via any media capable of being written by the source platform and read by the destination platform or platforms.

In another example, in the present embodiment, remote computing system 120 may comprise the source machine from which data is being generated/transmitted and computer system 52 may comprise the destination machine.

In a further embodiment, in the present disclosure, computing system 52 may comprise both a source machine from which data is being generated/transmitted and a destination machine. The remote computing system 120 may also comprise both a source machine from which data is being generated/transmitted and a destination machine.

Referring to FIG. 2, for the purposes of this disclosure, it will be appreciated that remote computer 120 may include any suitable term such as, but not limited to “device”, “processor based mobile device”, “mobile device”, “electronic device”, “processor based mobile electronic device”, “mobile electronic device”, “wireless electronic device”, or “location-capable wireless device,” including a smart phone or tablet computer.

The central processor operating pursuant to operating system software such as, but not limited to, Apple IOS®, Google Android® IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embedded directly in hardware, in a software module executed by a processor, or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

FIG. 3 shows a process architecture for an embodiment of the prediction system (300). When predicting the completion of a planned current project or goal, important variables to consider include past input from a project participant regarding their prediction of completed goal, the quality of work performed towards that goal, and whether the goal was completed successfully.

A project outcome calculation module (320) and a predictive index calculation module (340) may obtain information stored in the storage module (325) that includes past input from a project participant regarding their prediction of whether a goal will be completed, the quality of work performed towards that goal, and if the goal was completed successfully. The output from the project outcome calculation module (320) and the predictive index calculation module (340) may be stored in the storage module (325). The input from a project participant is received through the input module (310). The storage module (325) may also comprise historical data, which may include historical data relating to one or more project participant's. The historical data may comprise one or more of the project participant's past projects, an outcome of the past projects, a project participant's past predicted outcome of the past projects, a score indicating project participant's ability to predict project outcomes, or any combination thereof.

Some project participant may show a history of accurate predictions of a goal outcome. In this case, calculations may be altered to weigh more heavily the input from specific project participants.

A method of calculating and predicting a goal completion may include: (1) determining the total number of sub-goals that go into the goal whose outcome is being predicted, (2) grouping the sub-goals into a specific group which may include marketing goals, engineering goals, or sales goals, (3) dividing the grouped sub-goals by the total number of sub-goals, and (4) multiplying that number by the average prediction input from project participant's in the specific group. For improved accuracy, the number may be multiplied by a specific weight given by an expert or determined through predictive algorithms, or data analysis algorithms. Additionally, the level in the goal hierarchy is another possible factor in determining the weight of each metric.

Another exemplary method for calculating and predicting goal completion and/or determining predictive variables may include using historical data, specifically the associations between variables and the actual outcomes of goals, and a predictive model methodology, such as logistic regression, multinomial logistic regression, linear regression, support vector machine learning, a Bayesian classifier, a decision tree classifier, a copula-based classifier, a k-nearest neighbors classifier, a random forest classifier, neural networks, and boosting algorithms.

In some embodiments, a project outcome calculation module (320) may be employed to update the goal prediction models. The goal prediction models may be updated in response to an event such as a project participant's input, a goal being marked complete, the availability of new historical data, or other changes to data that is made available to the goal prediction model.

The predictive index method (327) indicates the project participant's ability to correctly predict the outcome of the project. The predictive index for the user may be generated manually by a project management expert, automatically using machine learning techniques, or a combination thereof. Adjustments to the predictive index may be made to weigh certain data sets as more important than other data sets. Weighing of data sets and data points may be made manually by a user with permission to make changes. For example, a project management expert may decide that adjustments to how much certain information is weighted in the predictive index. The expert may then make those adjustments within the software. The adjustments may be to all previous data, in which case a new calculation would be performed to update one or more project participants predictive index. However, the adjustments made by the expert may only impact calculations in the future, which would not require recalculating past predictive index results.

Machine learning techniques that may be used to automatically calculate and generate a predictive index for a project participant may include, but are not limited to: a Collective Matrix Factorization (CMF) technique, a Principal Component Analysis (PCA) technique, a Non-negative Matrix Factorization (NMF) technique, a Canonical Correlation Analysis technique (CCA), or an Inter-Battery Factor Analysis (IBFA) technique. There may be hundreds or even thousands of learning techniques applied, each of which performs different analysis to generate a predictive index.

The predictive index calculation module (340) used for calculating the predictive index may further be configured to generate and/or update the machine learning techniques from historical data associated project participant's as the historical data is updated.

The variables used to calculate the predictive index may include, but are not limited to, one or more parameters associated with the project participant, or multiple project participant's, such as, past input from the project participant including quality of work statement, predicted likelihood of the goal being completed, and actual outcome of the goal for which the project participant was predicting the outcome and determining the work quality. The parameters may also include time, date, weather, other project participant's, payment or salary, psychological screening, psychological analysis tests, psychometric assessments, career tests, IQ tests, emotional intelligence tests, personality tests, sentiment analysis, progress into current goal period, organizational relationship to other project participant's, organizational levels, and project participant's role in the organization. In some embodiments, the variables may include any data that may impact the outcome of the goal.

A hierarchical organization is an organizational structure where every entity in the organization, except one, is subordinate to a single other entity. Organizational data may relate to the organization in which the project participants and project managers are members. The organizational data may comprise information on the hierarchy of projects, or information on the hierarchy of project participants and project managers.

The results of the calculation by the project outcome calculation module (320) or predictive index calculation module (340) may be presented to a user through the presentation module (345).

FIG. 4 depicts the process flow for a project participant according to some embodiments of the present disclosure. In the project participant flow (440), step (442) represents a project participant accessing a portal or user interface that gives the project participant access to the system. The project participant may be presented with multiple questions as depicted in step (444). Possible questions include: what is the quality of work that is being performed towards the current project, or what is the likelihood that the current project will be completed as planned. In step (446) the project participant may provide answers to the questions presented in step (444). The project participant may be able to view a dashboard in step (448), where information regarding the current project may be presented. Information contained in the dashboard may include a matrix depicting a summary of other project participant's answers, input, responses, or a combination thereof, to the questions presented in step (444). The dashboard may also present an indication of the likelihood of the current project being completed as planned. From the dashboard, the project participant may have access to viewing their personal predictive index/score in step (450). Variations of this flow may include the project participant not being able to view other project participant's input as a matrix.

FIG. 5 depicts the process flow for a project manager (500) business manager or CEO according to some embodiments of the present disclosure. The flow begins with the project manager, business manager, or CEO accessing the portal to the system in step (542). The CEO may be presented with multiple questions as depicted in step (544). Possible questions include: 1) “What is the quality of work being performed towards the current project or the percentage of work completed?”, and/or 2) “What is the likelihood that the current project will be completed as planned?”, or combinations thereof. In step (546) the CEO may provide answers to the questions presented in step (544). The CEO may then be able to view a dashboard in step (548), where information regarding the current project may be presented. Information contained in the dashboard may include a matrix depicting a summary of other CEO answers, input, responses, or combinations thereof, to the questions presented in step (544). The dashboard may also present an indication of the likelihood of the current project being completed as planned. From the dashboard, the CEO may have access to viewing and accessing historical and current information of project participant's, groups within the organization, a task, a goal, or other components of the project in step (552). To access the information (552) the CEO may select the project participant, task, subgroup of the organization, or other components of the project (550). The CEO may additionally message or otherwise communicate with a selected project participant or multiple project participant's that have been selected (554).

In some embodiments, the CEO may not be presented with questions (544), and thus, the CEO will not proceed with providing answers in step (546). Instead the CEO will be presented with the dashboard (548) immediately after accessing the portal (542).

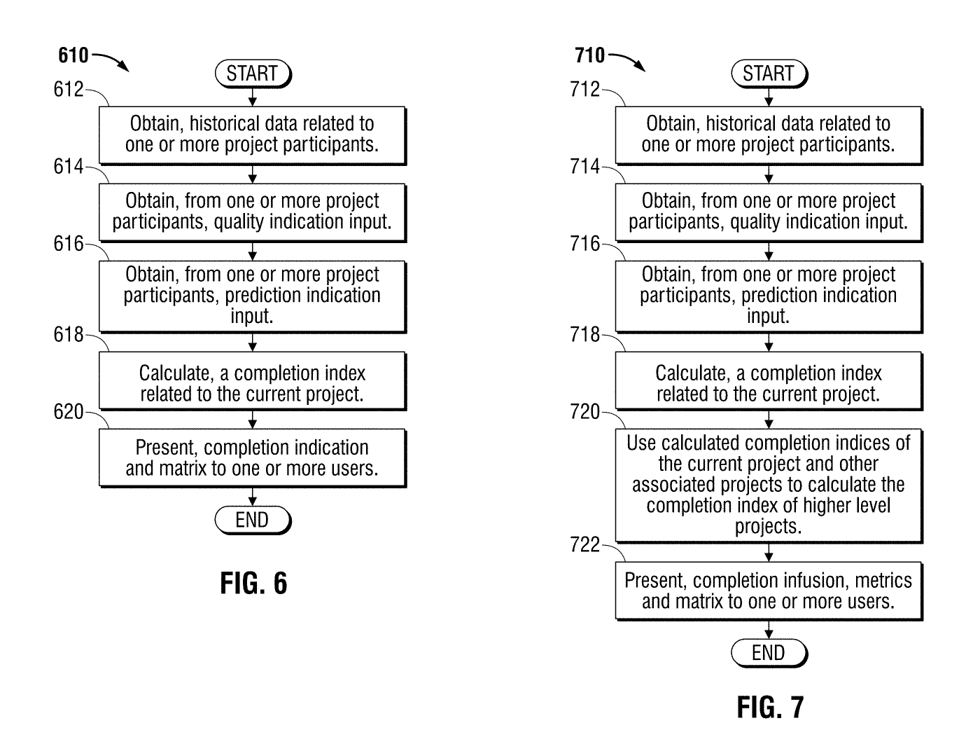

FIG. 6 shows a process flow (610) for the method and system of the present disclosure, including, at a functional level, components that may be associated for calculating and generating a project completion indication. In some embodiments, the operation may start with obtaining historical data (612) related to one or more project participant's. Second, the process may obtain, from one or more project participant's, a quality indication input (614). The quality indication is related to the quality of work performed on the current project, as determined by the project participant. Third, the process may obtain, from one or more project participant's, a prediction indication input (616). The prediction indication is related to the project participant's predicted outcome of the current project, as determined by the project participant. Fourth, the process may calculate a completion index related to the current project (618). The completion index is related to the likelihood of the current project being marked complete. Finally, the process may present the completion indication and a matrix and metrics of all project participant's input to one or more users (620).

FIG. 7 separately shows an alternative workflow (710) for how the present disclosure performs goal completion prediction. The process may begin with obtaining historical data (712) related to one or more project participant's. Second, the process may obtain, from one or more project participant's, a quality indication input (714). The quality indication is related to the quality of work performed by the project participant toward the current project, as determined by the project participant. Third, the process may obtain, from one or more project participant's, a prediction indication input (716). The prediction indication is related to the project participant's predicted outcome of the current project, as determined by the project participant. Fourth, the process may calculate a completion index related to the current project (718). The completion index is related to the likelihood of the current project being marked complete. Fifth, the process may use the calculated completion index of the current project and other associated projects to calculate the completion index of higher-level projects. Lastly, the process may present the completion indication and a matrix and metrics of all project participant's input to one or more user's (720).

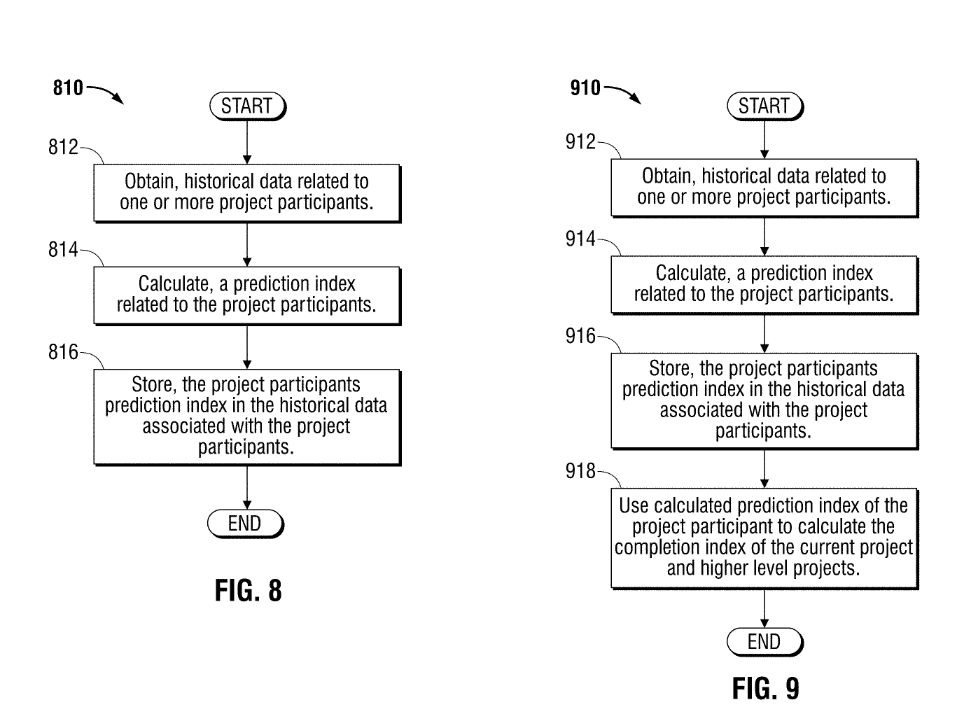

FIG. 8 shows an exemplary workflow for how the present disclosure creates a user predictive index (810). In some embodiments the operation may begin by obtaining historical data (812) related to one or more project participant's. Second, the process may calculate, utilizing the historical data, a prediction index related to the project participant (814). Finally, the process may store the project participant's prediction index in the historical data associated with the project participant (816).

FIG. 9 separately shows an alternative workflow for how the present disclosure performs goal completion prediction (910). In some embodiments, the operation may begin by obtaining historical data (912) related to one or more project participant's. Second, the process may calculate, utilizing the historical data, a prediction index related to the project participant (914). Third, the process may store the project participant's prediction index in the historical data associated with the project participant (916). Lastly, the process may use the calculated predictive index of project participant to calculate the completion index of the current project and higher-level projects (918).

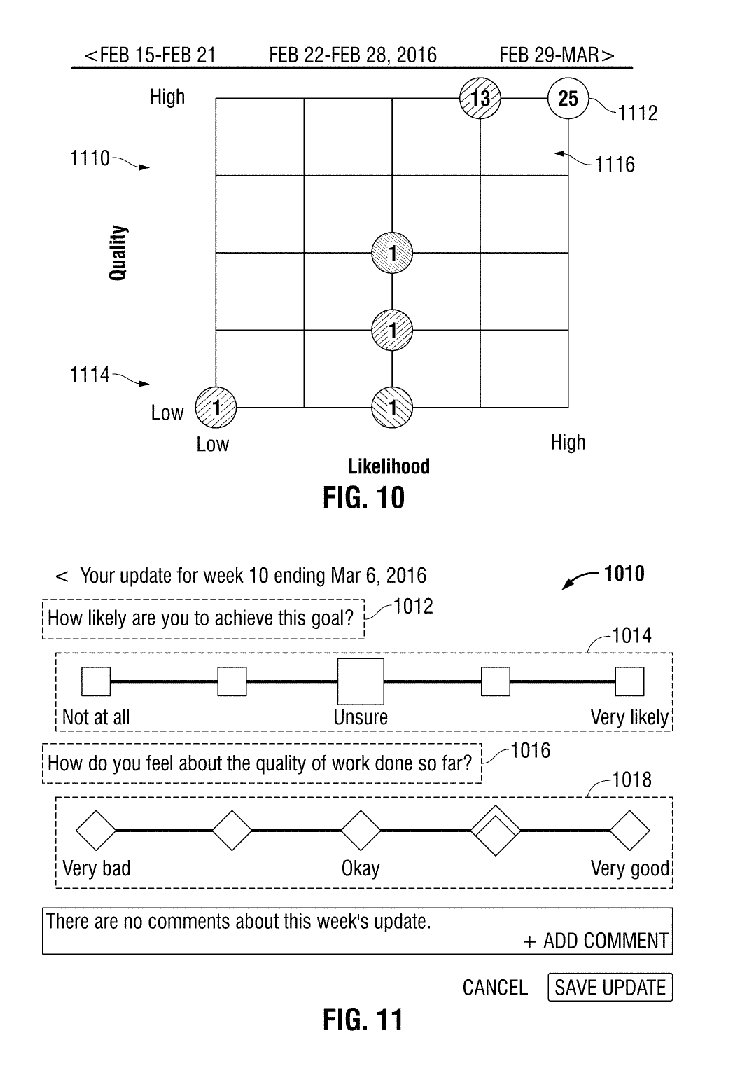

At FIG. 10 illustrates a Question Dashboard (1010) where a first question (1012) and a second question (1016) are generated and presented to a user. The questions that may be presented to the project participant or project manager include: 1) “How likely are you to achieve this goal?” (1012), and/or 2) “How do you feel about the quality of work done so far?” (1016). A user may select from input options (1014, 1018) that may be presented as shapes, colors, or text.

At FIG. 11 illustrates an exemplary Matrix Dashboard (1110) output as may be generated and presented to a user by embodiment through a graphical user interface that is. The matrix dashboard (110) groups similar responses (1112) from multiple project participant's and presents them on a matrix grid format. This view allows a project manager to easily see the responses from project participant's and see if any project participant's are at risk of not completing their tasks. Responses that indicate a greater risk of not completing the assigned task are shown towards the lower left corner (1114), whereas the responses that indicate high success of completion are grouped towards the upper right of the matrix (1116).

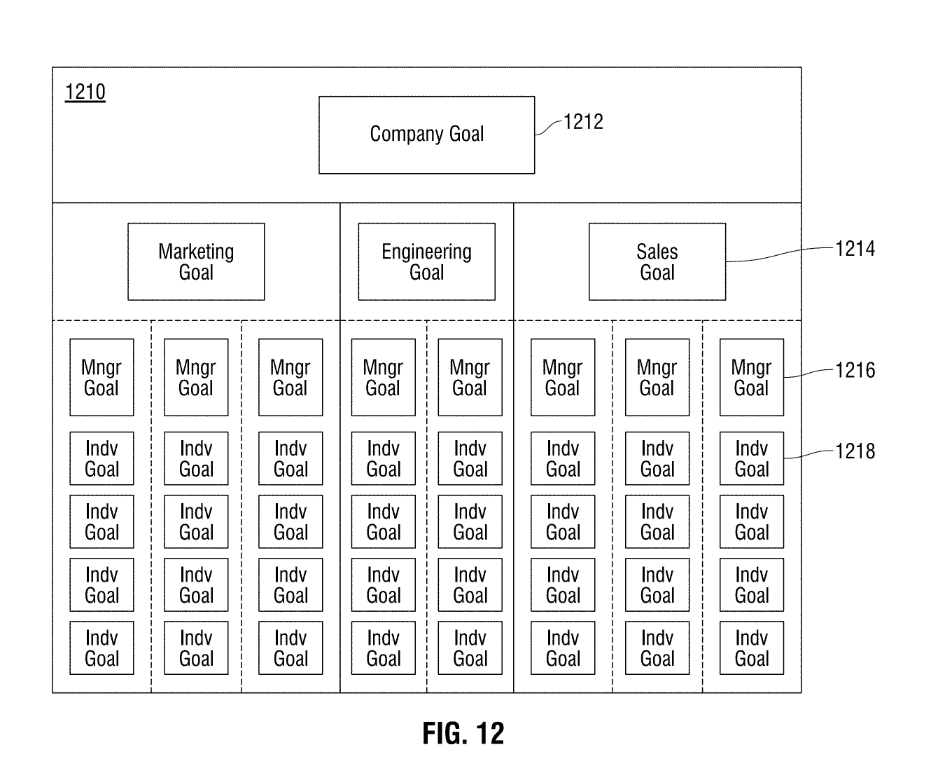

FIG. 12 presents an exemplary method for calculating a completion indication (1210). One method of calculating and predicting a goal completion indication (1210) may include: determining the total number of sub-goals (1214,1216,1218) that go into the goal whose outcome is being predicted (1212); grouping the sub-goals (1216,1218) into a specific group (1214) which may include marketing goals, engineering goals, or sales goals; dividing the grouped sub-goals (1214,1216,1218) by the total number of sub-goals going into the goal whose outcome is being predicted (1212), then multiplying that number by the average prediction input from project participant's in the specific group; and finally, adding up the results from each specific group (1214) to get the user predictive index (1210). For improved accuracy, the number may then be multiplied by a specific weight given by an expect or determined through predictive algorithms or data analysis algorithms.

In one embodiment, a computer-implemented method for predicting current project outcomes is described, providing a project manager with the certainty of those outcomes occurring, what projects participant's are most at risk of not completing their work, and what project tasks are at the most risk of not being completed for the project, the method comprising: obtaining, by a computing system, organizational data relating to the organization in which the project participants and project manager are members, wherein the organizational data comprises: information on the hierarchy of projects; information on the hierarchy of project participants and project managers; obtaining, by the computing system, historical data relating to one or more project participant's, wherein the historical data comprises: one or more of the project participant's past projects; an outcome of the past projects; a project participant's past predicted outcome of the past projects; and a score indicating project participant's ability to predict project outcomes; obtaining, by the computing system, from one or more project participant's, a quality indication, wherein the quality indication may be related to the quality of work performed by the project participant toward the current project; and a prediction indication, wherein the prediction indication may be related to the project participant's predicted outcome of the current project; calculating, by the computing system, a completion indication, wherein the completion indication may be related to the likelihood of the current project being marked complete, wherein, the completion indication may be calculated using one or more predictive models and data comprising: organizational data, one or more project participant's historical data, one or more project participant's quality indication, and one or more project participant's prediction indication; presenting, by the computing system, a completion indication and a matrix indicating one or more project participant's quality indication and predication indication. The completion indication may be calculated from data further comprising: a plurality of sub-projects and a plurality of subordinate project participant's, wherein the plurality of sub-projects and subordinate project participant's are determined by the organizational data. The score indicating project participant's ability to predict project outcomes may be calculated by the method comprising: obtaining, by the computing system, organizational data relating to the organization in which the project participants and project manager are members, wherein the organizational data comprises: information on the hierarchy of projects; information on the hierarchy of project participants and project managers; obtaining, by the computing system, historical data relating to the project participant's, wherein the historical data comprises: one or more past projects relating to the project participant; one or more outcomes relating to the one or more past projects; and one or more past prediction indications relating to the one or more past projects calculating, by the computing system, from the historical data, a predictive index indicating the project participant's ability to predict project outcomes.

In one embodiment, a computerized system for for predicting current project outcomes is described, providing a project manager with the certainty of those outcomes occurring, and what projects participant's are most at risk of not completing their work for the project, the system comprising: one or more processors; and a memory comprising instructions that, when executed by the one or more processors, cause the one or more processors to perform: obtaining organizational data relating to the organization in which the project participants and project manager are members, wherein the organizational data comprises: information on the hierarchy of projects; information on the hierarchy of project participants and project managers; obtain historical data relating to one or more project participant's, wherein the historical data comprises: one or more of the project participant's past projects; an outcome of the past projects; a project participant's past predicted outcome of the past projects; and a score indicating project participant's ability to predict project outcomes; obtain, from one or more project participant's, a quality indication, wherein the quality indication may be related to the quality of work performed by the project participant toward the current project; and a prediction indication, wherein the prediction indication may be related to the project participant's predicted outcome of the current project; calculate a completion indication, wherein the completion indication may be related to the likelihood of the current project being marked complete, wherein, the completion indication may be calculated using one or more predictive models and data comprising: organizational data, one or more project participant's historical data, one or more project participant's quality indication, and one or more project participant's prediction indication; present a completion indication and a matrix indicating one or more project participant's quality indication and predication indication. The completion indication may be calculated from data further comprising: a plurality of sub-projects and a plurality of subordinate project participant's, wherein the plurality of sub-projects and subordinate project participants are determined by the organizational data. The score indicating project participant's ability to predict project outcomes may be calculated by instructions stored on the memory that, when executed by the one or more processors, cause the one or more processors to: obtaining organizational data relating to the organization in which the project participants and project manager are members, wherein the organizational data comprises: information on the hierarchy of projects; information on the hierarchy of project participants and project managers; obtain historical data relating to the project participant's, wherein the historical data comprises: one or more past projects relating to the project participant; one or more outcomes relating to the one or more past projects; and one or more past prediction indications relating to the one or more past projects calculate, from the historical data, a predictive index indicating the project participant's ability to predict project outcomes.

In one embodiment, a computer readable medium comprising a system for for predicting current project outcomes is described, providing a project manager with the certainty of those outcomes occurring, and what projects participants are most at risk of not completing their work for the project, the computer readable medium comprising instructions for: obtaining organizational data relating to the organization in which the project participants and project manager are members, wherein the organizational data comprises: information on the hierarchy of projects; information on the hierarchy of project participants and project managers; obtaining historical data relating to one or more project participant's, wherein the historical data comprises: one or more of the project participant's past projects; an outcome of the past projects; a project participant's past predicted outcome of the past projects; and a score indicating project participant's ability to predict project outcomes; obtaining, from one or more project participant's, a quality indication, wherein the quality indication may be related to the quality of work performed by the project participant on the current project; and a prediction indication, wherein the prediction indication may be related to the project participant's predicted outcome of the current project; calculating a completion indication, wherein the completion indication may be related to the likelihood of the current project being marked complete, wherein, the completion indication may be calculated using one or more predictive models and data comprising: organizational data, one or more project participant's historical data, one or more project participant's quality indication, and one or more project participant's prediction indication; presenting a completion indication and a matrix indicating one or more project participant's quality indication and predication indication. The completion indication may be calculated from data further comprising: a plurality of sub-projects and a plurality of subordinate project participant's, wherein the plurality of sub-projects and subordinate project participant's are determined by the organizational data. The score indicating project participant's ability to predict project outcomes may be calculated by the method comprising: obtaining organizational data relating to the organization in which the project participants and project manager are members, wherein the organizational data comprises: information on the hierarchy of projects; information on the hierarchy of project participants and project managers; obtaining historical data relating to the project participant's, wherein the historical data comprises: one or more past projects relating to the project participant; one or more outcomes relating to the one or more past projects; and one or more past prediction indications relating to the one or more past projects; calculating, from the historical data, a predictive index indicating the project participant's ability to predict project outcomes.

The embodiments described above are exemplary and are not to be taken as limiting in any way. They are merely illustrative of the principles of the disclosure. Various changes, modifications and alternatives will be apparent to one skilled in the art. Accordingly, it is intended that the art disclosed shall be limited only to the extent required by the appended claims and the rules and principles of applicable law.

1. A computer-implemented method for predicting an outcome of a current at least one business project, business objective, and business goal, by utilizing instructions in a non-transitory computer-readable medium stored in a computing system, the method comprising:
obtaining, by the computing system, organizational data relating to an organization in which at least one participant and at least one manager are members, wherein the organizational data comprises:
information on a hierarchy of the at least one business project, business objective, and business goal;
information on a hierarchy of the at least one participant and the at least one manager;
obtaining, by the computing system, historical data relating to the at least one participant, wherein the historical data comprises:
at least one past business project, past business objective, and past business goal performed by the at least one participant;
an outcome of the at least one past business project, past business objective, and past business goal;
a past predicted outcome of the at least one participant's at least one past business project, past business objective, and past business goal; and
a score indicating the at least one participant's ability to predict the outcome of the at least one past business project, past business objective, and past business goal;
obtaining, by the computing system, from the at least one participant,
a quality indication, wherein the quality indication is related to the quality of work performed by the at least one participant toward the current at least one business project, business objective, and business goal; and
a prediction indication, wherein the prediction indication is related to the at least one project participant's predicted outcome of the current at least one business project, business objective, and business goal;
calculating, by the computing system, a completion indication, wherein the completion indication is calculated from data comprising a likelihood of the current at least one business project, business objective, and business goal being marked complete, participants among the at least one participant whom are most at risk of not completing their work, and business projects, business objectives, and business goals which are most at risk of not being completed;
wherein, the completion indication is further calculated using one or more predictive models and data comprising:
the organizational data,
the at least one participant's historical data,
the at least one participant's quality indication, and
the at least one participant's prediction indication; and
presenting, by the computing system, a completion indication and a matrix indicating the at least one participant's quality indication and the at least one participant's predication indication.

2. The computer-implemented method of claim 1, wherein the completion indication is further calculated from data further comprising: a plurality of sub-business projects, sub-business objectives, and sub-business goals, and a plurality of subordinate participants, wherein the plurality of sub-business projects, sub-business objectives, and sub-business goals and subordinate project participants are determined by the organizational data.

3. The computer-implemented method of claim 1, wherein the score indicating the at least one participant's ability to predict outcomes of the at least one business project, business objective, and business goal is calculated by utilizing additional instructions in the non-transitory computer-readable medium to perform a method comprising:
obtaining, by the computing system, the organizational data relating to the organization in which the at least one participant and the at least one manager are members, wherein the organizational data comprises:
the information on the hierarchy of the at least one current business project, business objective, and business goal;
the information on the hierarchy of the at least one participant and the at least one manager;
obtaining, by the computing system, the historical data relating to the at least one participant;
calculating, by the computing system, from the historical data, a predictive index indicating the at least one participant's ability to predict the outcome of the outcome of the at least one business project, business objective and business goal.

4. A computerized system for predicting an outcome of a current at least one business project, business objective, and business goal the system comprising:
at least one processor; and at least one non-transitory computer-readable medium stored in the at least one processor, the at least one non-transitory computer-readable medium comprising instructions that, when executed by the at least one processor, causes the at least one processor to:
obtain organizational data relating to an organization in which at least one participant and at least one manager are members, wherein the organizational data comprises:
information on a hierarchy of the current at least one business project, business objective and business goal;
information on a hierarchy of the at least one participant and the at least one manager;
obtain historical data relating to the at least one participant, wherein the historical data comprises:
the at least one participant's past business projects, business objectives, and business goals;
an outcome of the at least one past business projects, business objectives, and business goals;
the at least one participant's past predicted outcome of the at least one past business project outcome, business objective outcome, and business goal outcome; and
a score indicating the at least one participant's ability to predict the at least one past business project outcome, business objective outcome, and business goal outcome;
obtain, from the at least one participant,
a quality indication, wherein the quality indication is related to the quality of work performed by the at least one participant toward the current at least one business project, business objective, and business goal; and
a prediction indication, wherein the prediction indication is related to the at least one participant's predicted outcome of the current at least one business project, business objective, and business goal;
calculate a completion indication, wherein the completion indication is related to a likelihood of the current at least one business project, business objective, and business goal being marked complete, participants among the at least one participant whom are most at risk of not completing their work, and business projects, business objectives, and business goals which are most at risk of not being completed;
wherein, the completion indication is calculated using one or more predictive models and data comprising.
the organizational data,
the at least one participant's historical data,
the at least one participant's quality indication, and
the at least one participant's prediction indication;
present a completion indication and a matrix indicating the at least one participant's quality indication and predication indication.

5. The computerized system of claim 4, wherein the completion indication is calculated from data further comprising: a plurality of sub-business project, sub-business objectives and sub-business goals and a plurality of subordinate participants, wherein the plurality of sub-business projects, sub-business objectives and sub-business goals and subordinate participants are determined by the organizational data.

6. The computerized system of claim 4, wherein the score indicating participant's ability to predict the outcomes of business projects, business objectives, and business goals is calculated by additional instructions in the non-transitory computer-readable medium that, when executed by the at least one processor, causes the at least one processor to:
obtain organizational data relating to the organization in which the at least one participant and at least one manager are members, wherein the organizational data comprises:
information on a hierarchy of the current at least one business project, business objective, and business goal;
information on a hierarchy of the at least one participant and at least one manager;
obtain historical data relating to the at least one participant, wherein the historical data comprises:
one or more past business projects, past business objectives, and past business goals relating to the at least one participant;
at least one outcome relating to at least one past business project, past business objective, and past business goal; and
at least one past prediction indication relating to the at least one past business project, past business objective, and past business goal; and
calculate, from the historical data, a predictive index indicating the at least one participant's ability to predict the outcome of the at least one business project, business objective and business goal.

7. A non-transitory computer-readable medium adapted to be stored in a computing system for predicting an outcome of a current at least one business project, business objective, and business goal, the computer-readable medium comprising instructions for:
obtaining organizational data relating to an organization in which at least one participant and at least one manager are members, wherein the organizational data comprises:
information on a hierarchy of business projects, business objectives, and business goals;
information on a hierarchy of the at least one participant and the at least one manager;
obtaining historical data relating to the at least one participant, wherein the historical data comprises:
at least one past business project, business objective, and business goal performed by the at least one participant;
at least one outcome of the at least one past business project, business objective, and business goal;
a past predicted outcome of the at least one past business project, business objective, and business goal; and
a score indicating the at least one participant's ability to predict the outcomes of the at least one past business project, business objective, and business goal;
obtaining, from the at least one participant,
a quality indication, wherein the quality indication is related to a quality of work performed by the at least one participant on the current at least one business project, business objective, and business goal; and
a prediction indication, wherein the prediction indication is related to the at least one participant's predicted outcome of the current at least one business project, business objective, and business goal;
calculating a completion indication, wherein the completion indication is calculated from data comprising a likelihood of the current at least one business project, business objective, and business goal being marked complete, participants among the at least one participant whom are most at risk of not completing their work, and the business projects, business objectives, and business goals which are most at risk of not being completed;
wherein, the completion indication is calculated using one or more predictive models and data comprising:
the organizational data,
the at least one participant's historical data,
the at least one participant's quality indication, and
the at least one participant's prediction indication; and
presenting a completion indication and a matrix indicating the at least one participant's quality indication and predication indication.

8. The non-transitory computer: readable medium of claim 7, wherein the completion indication is calculated from data further comprising: a plurality of sub-business projects, sub-business objectives, and sub-business goals, and a plurality of subordinate participants, wherein the plurality of sub-business projects, sub-business objectives, and sub-business goals and subordinate participants are determined by the organizational data.

9. The non-transitory computer-readable medium of claim 7, wherein the score indicating the at least one participant's ability to predict outcomes is calculated by a method comprising:
obtaining the organizational data relating to the organization in which the at least one project participant and the at least one manager are members and;
calculating, from the historical data, a predictive index indicating the participant's ability to predict the outcomes.
